(19) United States
(12) Patent Application Publication
(10) Pub. No.: US 2006/0126174 A1
(43) Pub. Date: Jun. 15, 2006

(54) Retroprojection screen

(75) Inventor: Daniel Gibilini, Saint Martin D'Uriage (FR)

Correspondence Address: ROTHWELL, FIGG, ERNST & MANBECK, P.C., 1425 K STREET, N.W., SUITE 800, WASHINGTON, DC, 20005, US

(73) Assignee: SYNELEC TELECOM MULTIMEDIA, Saint Sernin Sur Rance (FR)

(21) Appl. No.: 10/551,787

(22) PCT Filed: Apr. 2, 2004
(86) PCT No.: PCT/FR04/00839

§ 371 Date: Jan. 5, 2006

(30) Foreign Application Priority Data
Apr. 2, 2003 (FR) 03/04125

(51) Int. Cl. G03B 21/56

(52) U.S. Cl. 359/460

(57) ABSTRACT

A rear projection screen has successively, starting from the projector and moving outwards, a Fresnel lens (6), a surface diffuser (8), a thin support (10) bonded onto a thick substrate (24) provided with an outer anti-glare (26) layer. Light emitted by the projector (2) is collimated by the Fresnel lens (6). It passes through a diffuser (a) having an elongated radiation diagram with a horizontal major axis. This diffuser provides spreading of light in the horizontal plane, so as to provide a wide horizontal angle of view. The light leaving the diffuser is received on a support (10) with cylindrical focusing elements (18) substantially parallel to the major axis of the diffuser radiation diagram and an opaque layer (20) with apertures (22) adapted to allow light focused by the focusing elements to pass. As the focusing elements are parallel to the major axis of the diffuser, practically all the light projected is transmitted. Thanks to the presence of the focusing elements, the display screen has an appropriate vertical angle of view. The presence of the opaque layer ensures optimized contrast in view of the rearward position of the diffuser (8) with respect to the support (10).

The present invention relates to a rear projection screen for professional and consumer applications (television, high resolution graphics workstation, video image walls, etc).

International application WO-A-0067071 discloses such a screen. Reference can be made to that application for a discussion on the ideal properties of screens and for definitions of contrast, transmission and other parameters defining screens.

Another important property for rear projection screens is the angle of view at the output from the screen. This angle is frequently measured both horizontally and vertically or with respect to the normal to the screen. This can be measured using either the extinction angle or the half-luminance angle. The extinction angle corresponds to the value of an angle to the normal for which the screen stops emitting light. The half-luminance angle is the value of the angle to the normal for which luminance has a value equal to half the luminance in the direction normal to the screen surface. The values of these angles of vision depend on the use to which the screen is put: thus, the angle of view in the vertical direction is not an important criterion for a domestic television set; on the contrary, for a graphics monitor, the angle of view in the vertical direction needs to be greater to allow a user to see the full height of images, at a short distance.

U.S. Pat. No. 5,066,099 (Hitachi) discloses a screen formed by a Fresnel lens and flat elements having vertical cylindrical lenticular elements on its entry face and cylindrical lenticular elements on its exit face, separated by ribs. The purpose of the lenticular elements is to ensure an open angle of view at the output from the screen in a direction orthogonal to the direction of the lenticular elements. A diffusion layer is provided on the output face and the ribs are covered by an opaque layer. In order to open up the angle of diffusion in the vertical direction, it is proposed to insert, between the Fresnel lens and the flat element, lenticular elements having horizontal cylindrical lens elements. Devices of the same type are disclosed in U.S. Pat. Nos. 5,590,943, 5,485,308 or 5,515,037.

U.S. Pat. No. 6,307,675 (Toppan) discloses a screen having, in the following order, a first element with horizontal cylindrical lens elements on the entry surface, a three-dimensional diffuser and a Fresnel lens on the output surface, and then a second element with vertical cylindrical lens elements and an alternating sequence of bands which are opaque or allow light to pass. A similar teaching of a three-dimensional diffuser can be found in U.S. Pat. Nos. 5,477,380, 6,271,965 or 6,400,504 (Dai Nippon Printing), or yet again in U.S. Pat. No. 6,256,145 (Sony) and United States Patent Application 2002/0,109,915 (Hitachi).

In all these documents, the angle of view in the horizontal direction is essentially provided by the presence, at the output from the screen, of vertical cylindrical lens elements. In general, for example in U.S. Pat. No. 5,066,099, these lens elements are non-spherical to increase the output angle of view. The contrast in these screens depends notably on the proportion of the screen surface made up by the openings in the black layer. In the Hitachi and Dai Nippon Printing Patents, the opaque layer makes up around 35% of the screen surface; U.S. Pat. No. 6,256,145 (Sony) indicates that the opaque layer makes up 65-75% of the screen surface.

U.S. Pat. No. 4,566,756 discloses a display panel formed from a single plate. This screen has an entry surface with lenticular elements, filaments extending substantially perpendicular to the direction of the lenticular elements and, on the output surface of the single plate, absorbent strips around the focal lines of the lenticular elements. Integrating the optical functions into a single plate, in particular contrast and horizontal and vertical emission angles leads to a detrimental tradeoff regarding characteristics such as contrast, optical transmission and screen resolution. Further, the diffusing filaments are supposed to also reinforce the plate of thickness around 1.5 mm: this is hypothetical and limits screen dimensions. The proposed pitch or period values in that patent correspond to bottom-of-the-range television applications. This type of screen is not easy to produce industrially, and has furthermore never appeared on the market at the time this application was filed.

J. M. Tedesco et al, Holographic Diffusers for LCD Backlights and Projection Screens, SID 93 Digest, pages 29-32 discloses three-dimensional or surface holographic diffusers. In rear projection applications, it is proposed to use such diffusers in combination with a Fresnel lens, instead of a conventional diffuser and a matrix of lens elements.

Robert C. Bush, Reflexite Display Optics, Rear Projection Screens for Different Applications discloses rear projection screens made up by a Fresnel lens and a diffusion screen. Reflexite Display Optics is also selling surface relief diffusing micro-structures or SRDMs, allowing light to be diffused with a predetermined gain distribution.

There is still a requirement for a rear projection screen having contrast and angle of view characteristics as high as possible which is also simple to produce and the characteristics of which can readily be adapted.

The invention consequently provides, in one embodiment, a display screen comprising, along the direction of propagation of projected light:
a diffuser having an elongated radiation diagram with a horizontal major axis;
a support with a light entry surface having cylindrical focusing elements substantially parallel to the major axis of the radiation diagram of the diffuser, the support further having an opaque layer with apertures adapted to allow the light focused by said focusing elements to pass.

The screen can advantageously have one or more of the following characteristics:
the diffuser has a radiation diagram with a half-luminance angle less than ±10%, or even ±5%, in the vertical direction.
the diffuser has a radiation diagram the elongation of which is greater than 6, preferably greater than 12.
the apertures in the opaque layer make up at the most 30% of the total surface, or even at the most 20%, and preferably at the most 10% of the total surface.
the diffuser is a surface diffuser.
the active surface of the diffuser is directed towards the support.
the diffuser is a holographic diffuser with an active surface opposite the support.
the display screen further comprises a supplementary diffuser, such as a conical diffuser or one having a maximum scattering angle less than the vertical scattering angle of the elongated radiation diagram diffuser.
the supplementary diffuser is a surface diffuser formed on a surface of the elongated radiation diagram diffuser.
the supplementary diffuser is a surface diffuser formed adjacent to the opaque layer.
the display screen has a substrate disposed above the opaque layer.

In a preferred embodiment, the display screen also has a Fresnel lens with its active surface directed towards the elongated radiation diagram diffuser. A vertical lenticular element can be provided at the entry to the Fresnel lens.

In this case, the screen can advantageously have one or more of the following characteristics:
the supplementary diffuser is a surface diffuser formed on the entry surface of the Fresnel lens.
it has an optical transmission greater than or equal to 0.70.
a half-luminance emission angle in a horizontal plane greater than ±48° and by an extinction angle in the horizontal plane greater than ±72 degrees.
a resolution on a horizontal axis greater than 10 line pairs per mm.

The Fresnel lens, the diffuser, the support and the substrate can be assembled by peripheral bonding. On at least one non-scattering surface, an anti-glare layer, preferably of the moth-eye type can be provided. An anti-glare layer can be provided on all non-scattering layers. The support, at the side of the opaque layer, can be bonded onto the substrate.

The screen can have an outer frame in which there are mounted the substrate, a first frame supporting the diffuser and a second frame supporting the Fresnel lens.

The invention also provides a rear projector unit comprising a projector and such a display screen, the Fresnel lens being adapted to collimate the light leaving the projector.

The rear projector unit has a contrast better than 500 under ambient illumination of 100 lux, for a luminous flux from the projector of 500 lumens.

Further characteristics and advantages of the invention will become more clear from the description which follows of various embodiments thereof provided by way of example and with reference to the drawings.

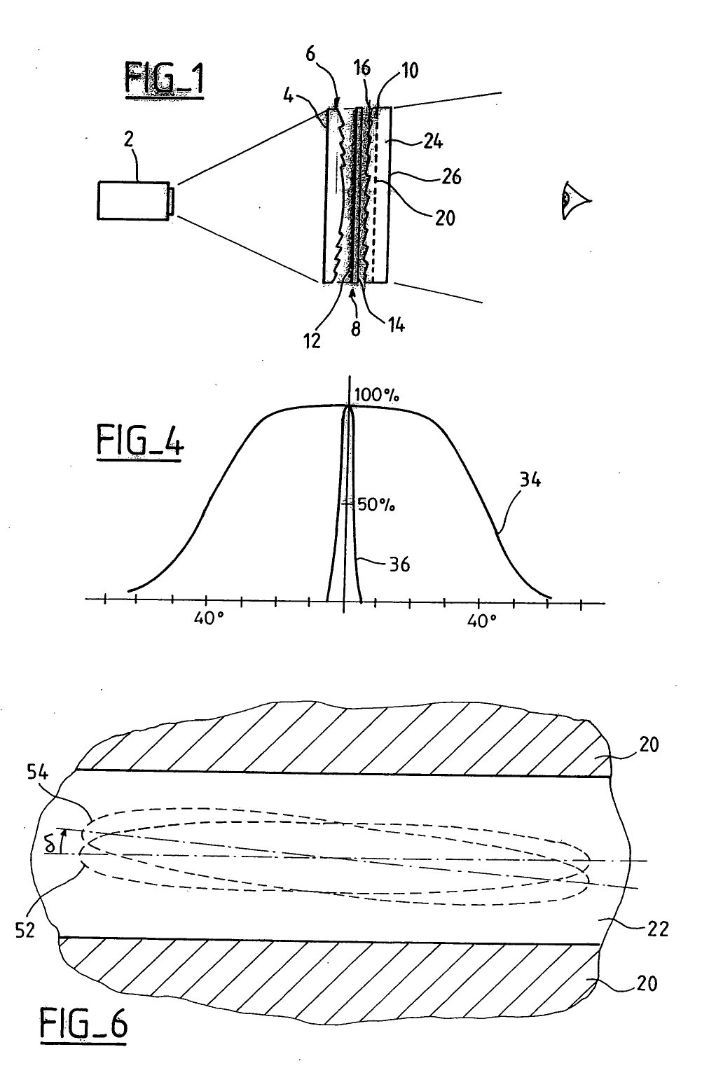

FIG. 1 is a diagrammatic view in vertical section of a rear projection display employing a screen according to the invention.

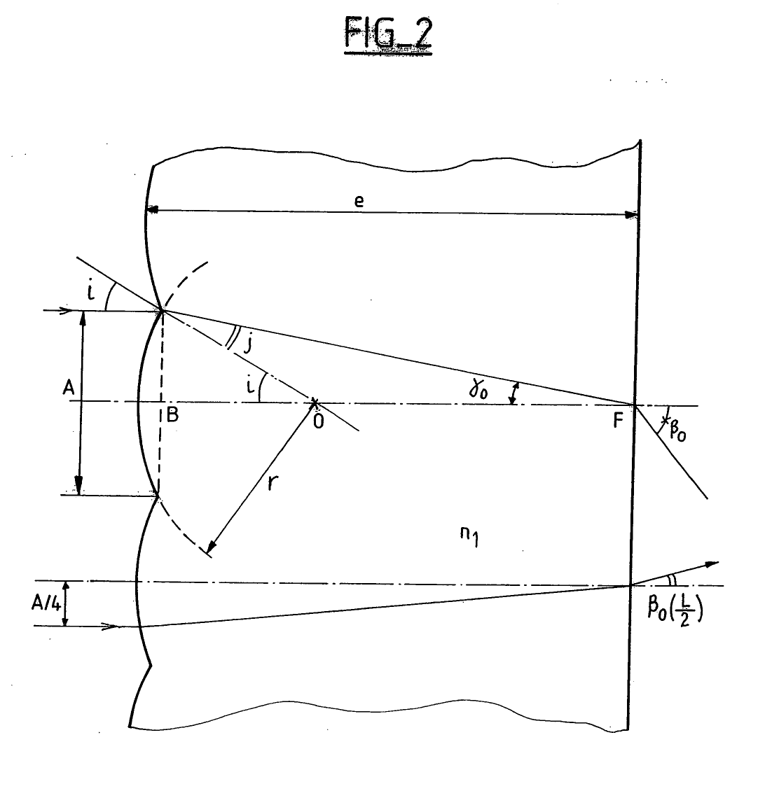

FIG. 2 is a diagrammatic view of a cylindrical focusing element.

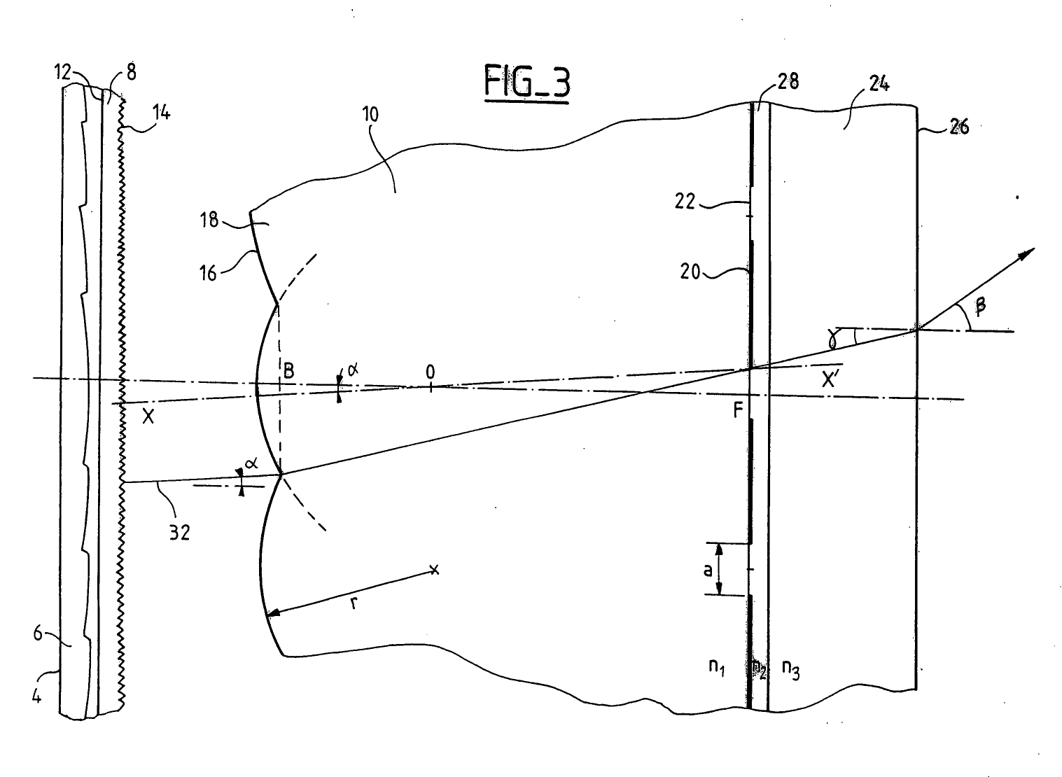

FIG. 3 is a schematic view on a larger scale of part of the screen and of the Fresnel lens.

FIG. 4 is a graph showing a radiation diagram for the diffuser of the screen.

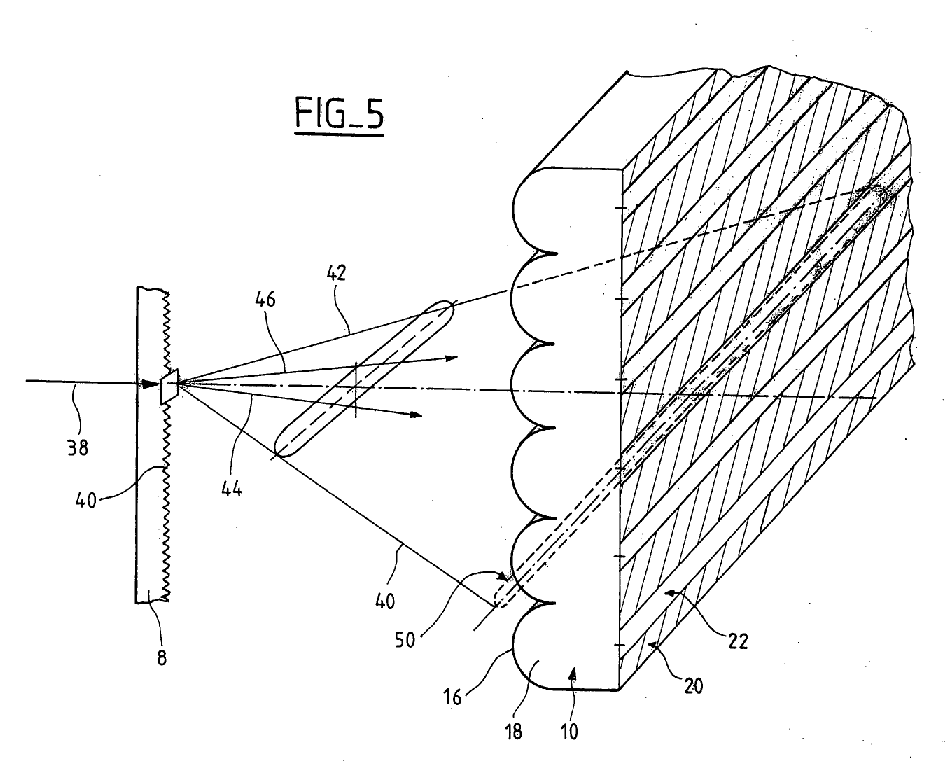

FIG. 5 is a diagrammatic view in partial perspective of the screen.

FIG. 6 is a view of the opaque layer showing the radiation diagram.

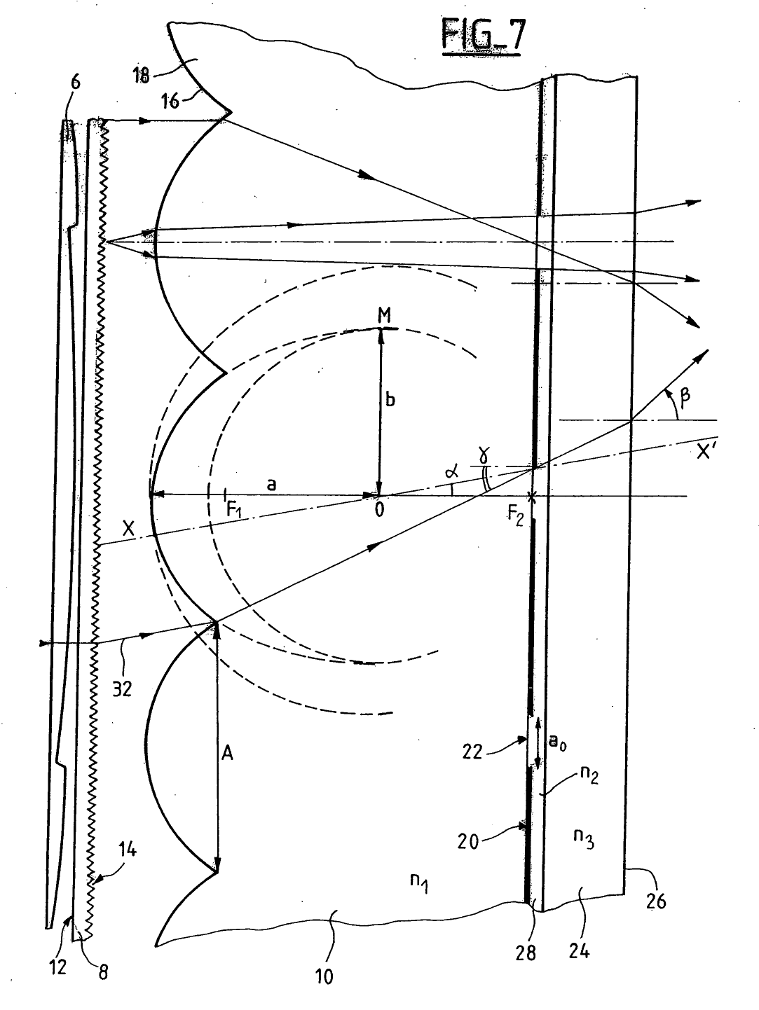

FIG. 7 is a diagrammatic view of a screen with non-spherical focusing elements.

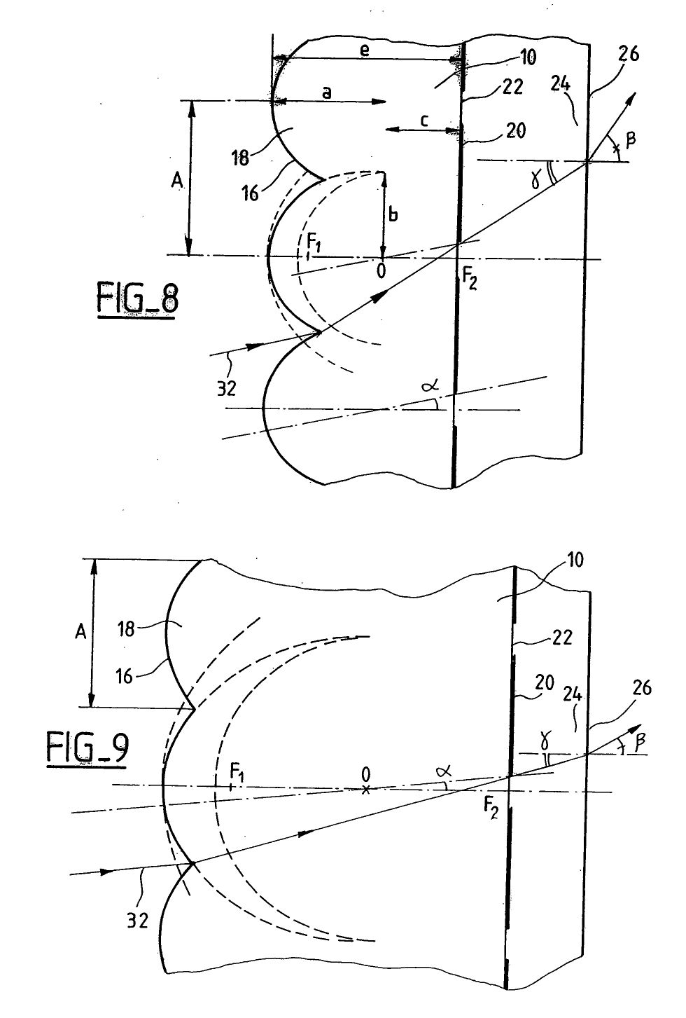

FIG. 8 shows a non-spherical lens element carrier adapted to a screen for a graphics monitor or a video image wall.

FIG. 9 shows a non-spherical lens element carrier adapted to a television screen.

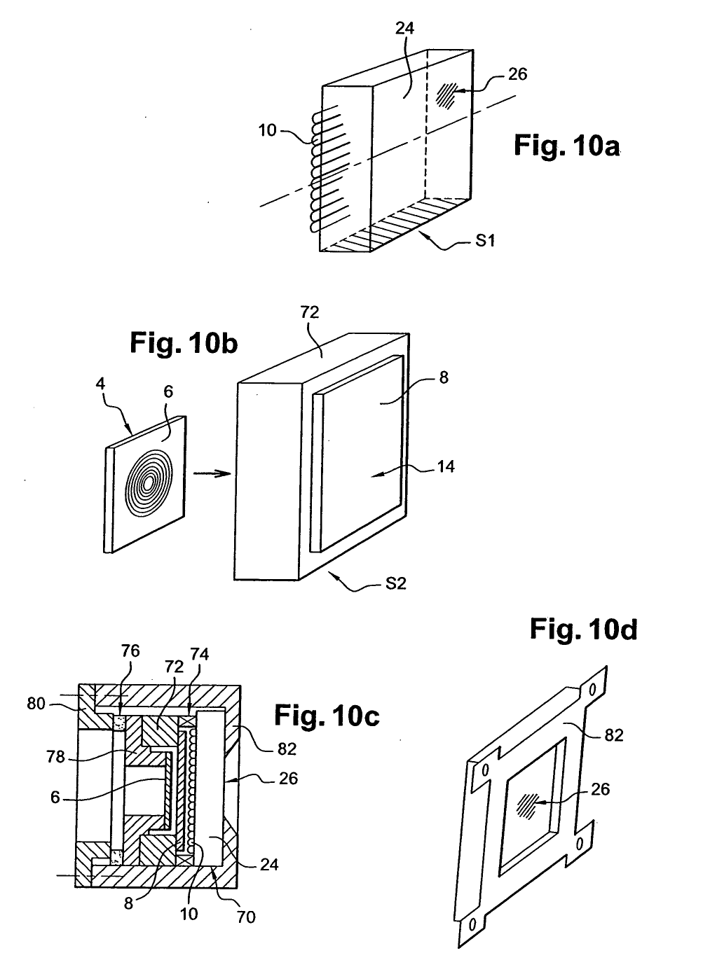

FIGS. 10a to 10d show constructional details of a screen; and

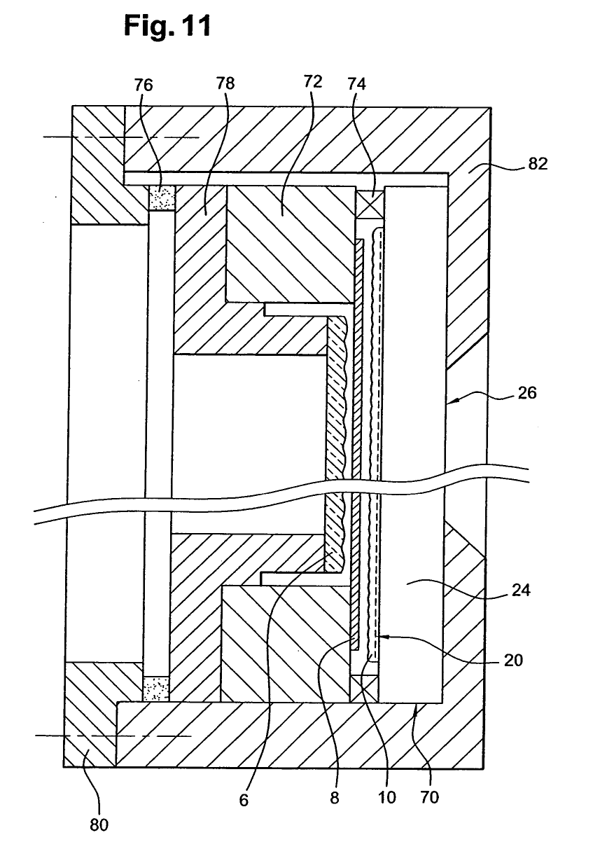

FIG. 11 shows a cross section on a larger scale of the screen.

Below we shall use the term “diffuser” to mean an optical object which, upon receiving a light beam, outputs a plurality of light beams in different directions. As explained below, a surface diffuser means a diffuser in which a continuous surface separates two different refractive index media; one can distinguish “conventional” surface diffusers and holographic surface diffusers. In a conventional surface diffuser, there is one refracted ray corresponding to a ray incident on the surface. Nevertheless, two rays that are very close are refracted in very different directions; we can thus, by approximation, consider that an incident light beam is transformed into a plurality of beams. This leads to the desired diffuser effect.

Further, for a holographic surface, an incident ray is transformed into several diffracted rays. One can further consider that an incident beam is transformed into several diffracted beams.

We can make a distinction between diffusers as a function of their operating mode and fabrication of surface and three-dimensional diffusers. A three-dimensional diffuser is for example obtained by an “emulsion” of particles in a transparent matrix of refractive index n1; if the particles are very fine (less than 1 micron), there is diffraction of light; if they are larger and of refractive index n2 (with n2>n1) as is the case in TV screen lenticular elements, there is light refraction.

A surface diffuser does not use particles in a volume, but rather a complex and continuous surface separating two media of different refractive indices. The complex and continuous surface has a thickness which is typically less than 10 micron (peak-to-peak distance). Such a diffuser can for example comprise a surface holographic diffuser produced by interference of light with a surface, or by replication of a master surface. Such a diffuser can also comprise a surface diffuser of which one surface has small dimension irregularities, typically less than 10 microns thick. These irregularities can be obtained by sand blasting, by replication or some other process. Media of different refractive indices can be air and a material such as plastic; one can also use a medium of refractive index n1 having a complex surface and a second medium of refractive index n2 that is different, applied to the first medium to fill and flatten off (or surface) the roughness of the first medium.

A screen is characterised in particular by angle of view, most frequently in horizontal and vertical directions. In the horizontal direction, we shall consider the direction of maximum luminance—generally, the normal to the screen; next we measure the angle between this direction of maximum luminance and the direction for which the luminance is equal to half the maximum luminance. This angle corresponds to the half-luminance vision half angle. The half-luminance angle of view in the horizontal direction, supposing the screen has a symmetrical radiation diagram, is equal to twice this half angle. One can also measure the angle of view at light extinction by considering the angle between the direction of maximum luminance and the direction of extinction. We proceed in the same way in the vertical direction. Below, although this is incorrect but is the practice of those skilled in the art, we shall use the term “angle of view” to designate both the half angle and the angle itself; in particular, the notation ±α designates the angle of view, where α is the half angle. Below, the notation α(L/2) will also be used for designating the half angle.

In one embodiment, the invention provides a screen comprising
a diffuser having an elongated radiation diagram with a horizontal major axis;
a support with cylindrical focusing elements substantially parallel to the major axis of the radiation diagram of the diffuser and an opaque layer with apertures adapted to allow the light focused by the focusing elements to pass.

FIG. 1 is a diagrammatic view in vertical section of rear projection apparatus employing such a screen while FIG. 2 shows lenticular elements and FIG. 3 shows a part of the screen on a larger scale. FIG. 1 shows a projector 2, which is for example a liquid crystal projector or DMD projector formed by a matrix of mirrors; application to TV with a CRT projector is also possible. The light emitted by the projector arrives on the entry surface 4 of the Fresnel lens 6 of the screen and exits, substantially collimated, via the output surface of the Fresnel lens. The screen has a diffuser 8 and a support or carrier 10 with focusing elements. The diffuser 8, in the example of FIG. 1, is a surface holographic diffuser having an active surface 12 directed towards the Fresnel lens and a plane surface 14 through which light that has passed through the diffuser exits. As indicated above, the diffuser has an elongated radiation diagram, with a major horizontal axis. This axis can be defined in the most general case by considering curve that delimit the illuminated region in a plane parallel to the diffuser, when the latter is illuminated with normally incident light. The major axis is defined by the pair of points the most distant on this curve and corresponds to the direction of elongation of the radiation diagram. An elongation can be defined by considering a rectangle on which the curve is inscribed; the elongation is then the ratio between the length and the width of the rectangle. One can further define a minor axis in a direction perpendicular to the major axis. In the example of an elliptical radiation diagram, which is an example of a symmetrical radiation diagram, the curve is an ellipse and the major axis passes through the two foci of the ellipse. One can then define a minor axis perpendicular to the major axis and which constitutes the median for the two foci.

FIG. 1 shows the example of a holographic diffuser; it is advantageous for the active surface of the diffuser to be the light entry surface, receiving rays coming from the Fresnel lens. This ensures better holographic diffuser performance in emission lobe terms. As the diffuser can be very thin—of the order of 125 μm, loss of resolution due to scattering ahead of the focusing elements is negligible. An SRDM can also be used as a diffuser; such a diffuser can operate with light entering or exiting via the active surface.

It is advantageous for the active surface of the diffuser to be the light exit surface, adjacent to the focusing element support; this limits loss of resolution by scattering within the diffuser. The active surface is then arranged as close as possible to the focusing elements of support 10. In both cases, the advantage of a surface diffuser compared to a three-dimensional diffuser is higher transmission associated with moderate backscattering.

One can also use a surface diffuser of another type other than a holographic or SRDM diffuser. For example, a surface diffuser with microgrooves oriented vertically provides significant scattering in the horizontal direction and low or zero scattering in the vertical direction. Such a diffuser can be obtained by directional sand blasting or by etching or, yet again, by replication using a photoresist from a master diffuser produced by sand blasting or etching.

Focusing element support 10 receives the light coming from the diffuser. It has a light entry surface 16 with cylindrical focusing elements 18; by cylindrical we mean a surface defined by a family of parallel straight lines residing on a curve, this definition being wider than that of a simple cylinder of revolution. The focusing elements can consequently have the shape of an arc of a circle in a plane perpendicular to the straight lines of the family; one can also use non-spherical focusing elements with a shape other than that of an arc of a circle: ellipsoid, parabolic or with other suitable profiles as per U.S. Pat. No. 4,490,010 (DNP). Such a shape contributes to spreading of light rays and can also allow the angle of view to be controlled in the direction perpendicular to the straight lines of the family. Examples are given in reference to FIGS. 7, 8 and 9.

The focusing elements are substantially parallel to the major axis of the diffuser, which is equivalent to saying that the straight lines of the family defining them are substantially horizontal. Ideally, the focusing elements are exactly parallel to this major axis. In practice, in view of assembly constraints, the focusing elements can make an angle with the major axis of the diffuser, as explained later with reference to FIG. 6.

The support also has an opaque layer 20, with openings 22 adapted to allow the light focused by the focusing elements to pass. This opaque layer extends, for example, in the focusing plane of the focusing elements and has elongated openings parallel to the focusing elements. This layer can be formed by the methods described in international application WO-A-0067071 or in French patent applications serial numbers 02/02086, 02/10885, 02/10829 or 02/12987. One can, for example, expose the photosensitive layer thereof through the focusing elements or locally destroy the opaque layer thereof using a laser or otherwise, through the focusing elements.

Support 10, which is flexible, provided with the etched opaque layer 20 is bonded onto rigid substrate 24, provided with anti-reflective layer 26. This anti-reflective layer can be of an economical plastic type having a moth-eye structure, replicated in the substrate surface, or have a dielectric multi-layered structure obtained by evaporation or a sol-gel method.

A moth eye-type anti-reflective layer has a reflection coefficient R₁ of 0.1% from 0° to 40° light beam incidence angle; this reflection coefficient is limited to 1% for an angle of incidence of 60°, compared to a value of 10% for an acrylic-air interface. In this example, it is-proposed to apply a moth-eye anti-reflective layer, or other, on all non-scattering surfaces of the assembly comprising Fresnel lens, diffuser, support and substrate; in particular, one can apply such a layer to the light entry surface of the Fresnel lens, where the angle of incidence in the corners can be high in the case of a compact design of projector (see U.S. Pat. No. 5,590,943, Hitachi, with angles that can reach 70°). One can further apply such a layer to the surface 16 of the lenticular elements 18 at which the angle of incidence of the light beam can reach 40° or more at the edge of the lenticular elements 18. As explained elsewhere, one can also, or alternatively, provide an anti-reflective layer on the diffuser or on the substrate. The presence of this or these anti-reflective layer(s) is beneficial to the optical transmission of the screen and center-to-edge uniformity of this transmission.

FIG. 2 is a larger scale view of the focusing elements in the example, the focusing elements being portions of width A of half cylinders of revolution of radius R. The support has a thickness e. The light output plane of the support 10 is practically the focal plane of the lenticular elements 18. In the example of FIG. 2, the focusing element support has a refractive index n1. The following hold:
sin i=A/2r
sin β₀=n1·sin γ₀
γ₀=i−j
sin j=sin i/n1
e=r+OF
OF=BF−OB=A/(2tgγ₀)−r cos i
e=r(1−-cos i+A/(2r·tan γ₀))
   for the examples of cylindrical lenticular elements of FIGS. 2 and 3, with n1=1.5. The thickness e is close to 2.8×r.

FIG. 3 shows, on a larger scale, a screen with the focusing elements of FIG. 2; we have considered the example of a surface diffuser with an active surface directed towards the focusing elements. As FIG. 3 shows, a substrate 24 is bonded onto the opaque layer with an anti-reflective layer on the surface 26 of the substrate. The substrate provides both mechanical rigidity for support 10 and protection of the opaque layer. For television or graphics monitor applications, it is judicious to assemble by bonding at the edges, outside of the useful field of the various elements of the screen: the Fresnel lens, the diffuser and the lenticular elements support provided with the opaque layer bonded onto the substrate 24 which then provides the mechanical rigidity of the rear projection screen; this solution is simple, but increases surface area of the edges, which is inapplicable for large screen video image walls; in this case, a stack of elements clipped together at their periphery is recommended.

The screen of FIGS. 1 and 3 operates as follows. The light emitted by the projector is collimated by the Fresnel lens and arrives consequently with normal incidence at the diffuser. It is scattered in accordance with the diffuser radiation diagram and arrives on the cylindrical focusing elements of the support. As the radiation diagram of the diffuser is elongated with a horizontal major axis, the rays leaving the diffuser are in planes slightly inclined with respect to the horizontal plane, and are focused by the focusing elements towards the openings in the opaque layer. One will consequently understand that practically all the rays originating from diffuser 8 can pass through the opening 22, even if these openings have a small surface area; this is provided that the vertical emission angle at extinction of the diffuser is adapted to this surface of the openings (as illustrated below). In this way, the horizontal angle of view at the output from the screen is determined essentially by the characteristics of the diffuser; specifically, the horizontal angle of view is equal to the aperture angle of the radiation diagram of diffuser 8 along the major axis.

Light ray scattering in the vertical direction is principally provided by the lenticular elements, as is illustrated in the examples below.

The advantages of the screen in FIGS. 1-3 are as follows. As horizontal angle of view is essentially determined by the radiation diagram of the diffuser, this angle can be adapted simply, by changing the diffuser. The screen can consequently be very readily modified to adapt it to various angles of view in the horizontal direction. One can also obtain horizontal angles of view as high as desired—simply by choosing a diffuser having a high horizontal scattering angle.

Further, and by supplying a diffuser having a very flattened radiation diagram—with a small angle in the vertical direction—it can be ensured that rays incident on the focusing element support are substantially horizontal. It is consequently possible to provide, in the opaque layer, openings of small size without simultaneously harming screen transmissivity. Thanks to this, the screen can have high contrast.

The screen can also have high resolution. Horizontal screen resolution is practically equal to that of the diffuser as the lenticular element array has no influence on the horizontal; values greater than 10 pl/mm (pairs of lines per millimetre) are common for a surface diffuser. In the vertical direction, resolution corresponds to twice the distance between two openings in the opaque layer, thus twice the period of the lenticular element array: indeed, two lenticular elements are necessary in order to clearly separate, with modulation better than 30%, a line that is lit (on) from a line which is unlit (off). As illustrated by the examples below, the period of the lenticular element array of the invention is A=150 μm typical; this leads to a vertical resolution of 1/2 A=3.3 pl/mm.

For television applications in which information spreads considerably in the horizontal direction, the invention leads, consequently, to a horizontal resolution that is well above that of the state-of-the-art; the latter involving use of a vertical lenticular element array which limits horizontal screen resolution.

The screen also minimises moire phenomena. Such phenomena are brought about by superimposition of regular structures—for example pixels of LCD or DMD displays, microrelief patterns of the Fresnel lens, the lenticular elements at the light output, in the case of a state-of-the-art device. The presence of a diffuser in the screen limits or eliminates moire phenomena. This is particularly the case when a random surface structure holographic diffuser is used arranged between the Fresnel (periodic) lens and the focusing element (periodic) support. Using a periodic SRDM type diffuser can lead to limited moire phenomena arising through the periodicity of the active surface elements.

In FIG. 3, the elements already described will be recognised and are not discussed again. Reference numeral 28 is a layer of adhesive laminated or otherwise disposed between opaque layer 20 and substrate 24, for the assembly of support 10. By way of example, for a television or graphics monitor application, one can consider a substrate 4 mm thick, in plastic, with an anti-reflective layer, on which a transparent adhesive film of the type sold by Rexam is pre-laminated; the latter is a pressure sensitive adhesive widely used in the production of liquid crystal monitors. A focusing element support can have a thickness of 150 to 500 μm; the support and opaque layer formed on the support are laminated onto the adhesive film of the substrate. The diffuser and its support are bonded onto the edges of the assembly, and the Fresnel lens is laminated onto the edges of the assembly. For a video image wall application, the lenticular element substrate is cut out. The assembly comprising substrate and support with focusing elements, diffuser and its support as well as the Fresnel lens are assembled by clips and assembly elements at the edges, so as to provide a screen having edges which are as thin as possible.

As FIG. 2 shows, the distance between two adjacent focusing elements 18 is indicated by A and this is also the size of a lenticular element in the vertical direction. The distance e between the surface of the focusing elements and the opaque layer corresponds to the thickness of the focusing elements; on FIG. 3, a is the dimension in a vertical direction of the openings in the opaque layer. n1, n2 and n3 are the respective refractive indices of the lenticular elements, the adhesive and the substrate; in this diagrammatic representation, we have considered the case of identical refractive indices; the value of the common refractive index is referred to by n below. The ratio a/A is the percentage X% of openings in the opaque layer.

Towards the middle of FIG. 3, a ray XX′ passing through the center O of a lenticular element and passing through the corresponding edge of the opening 22 in the opaque layer has been shown. α is the angle the ray XX′ makes with the normal. FIG. 3 shows the ray 32 emitted just before extinction in the vertical direction, incident with an angle α at the edge of a lenticular element, passing through the edge of the corresponding opening 22. α is the angle at extinction for the diffuser.

γ is the angle of incidence of ray 32 on the opaque layer which, because the refractive indices are the same in the example, is also the angle with which ray 32 is incident on surface 26 of substrate 24.

Ray 32 leaves the screen making an angle β with the normal to the screen.

The following relations hold for the example of FIG. 3:
tgα=a/2OF
OF=e−r; for n₁=1.5 we have OF 1,8 r
tan α=X%/(3.6 r/A)
tan γ=(A/2+a/2)/(OF+OB) with OB=r·cos i
tan γ=(1+X%)/[(2 ·r/A)(1.8+cos i)]
sin e=n₁. sin γ regardless of the values of refractive indices n2 and n3.

If the limiting angle of the diffuser radiation diagram in the vertical direction is less than or equal to this angle α, all the rays leaving diffuser 8 which are incident on the lenticular elements 18 pass through the opaque layer through the openings. One can thus assure 100% transmission for the screen, neglecting attenuation. From this point of view, it is judicious to adapt the size of the openings in the opaque layer to the value of the diffuser radiation diagram angle in the vertical direction. The greater this angle, the wider the openings in the opaque layer need to be to allow total or practically total transmission. Aperture size has an incidence on screen contrast: the smaller the openings, and the greater light incident on the screen from outside—the right hand side in the figure—is absorbed. This appears clearly from the calculation of contrast discussed below.

Because of the alignment of the lenticular elements and the openings with the major axis of the radiation diagram, light can be spread in the horizontal direction without this harming screen transmission.

To limit astigmatism, it is preferable to operate under Abbe conditions, in other words as close as possible to the optical axis of the lenticular elements; it is consequently useful for A to be strictly less than r. If this is not the case, it remains possible to employ non-spherical lenticular elements in order to correct the inherent astigmatism where r<A<2·r. This correction is less pronounced than that required for spreading light in the horizontal plane of prior art screens which also require correction for astigmatism. The use of non spherical elements is suggested in U.S. Pat. No. 6,256,145, column 3, lines 19-27.

FIG. 4 shows the shape of the radiation diagram for the diffuser. The y-axis shows relative luminous intensity and the x-axis the angle. The graph shows typical results from measurement 34 in the horizontal direction and a measurement 36 in the vertical direction. The example is that for a holographic surface diffuser of the type supplied by POC of Torrance, USA, for half-luminance angle values of ±40° on the major axis and ±2° on the minor axis. These values substantially correspond to extinction at ±62° and at ±4° in these same directions. These values are well within the limits announced by POC: they are offering diffusers with a ±48° half-luminance radiation diagram equivalent to ±72° at extinction, on the major axis; on the minor axis, the minimum value announced is ±0.1° at half-luminance equal to ±0.2° at extinction.

The table below gives examples for lenticular elements supplied by Reflexite Displays-Optics; the values for A and r are given by the manufacturer, the angles i, j et β₀ as well as the ratio e/r are calculated as explained with reference to FIG. 2. The angle β₀(L/2) at half-luminance corresponds to the incident beam with sin i=A/4r below and above which the luminous flux of the projector is divided between two equal parts.

| Reference | r (mm) | A (mm) | e/r | i (°) | j (°) | β₀ (°) | β₀(L/2) (°) |
|---|---|---|---|---|---|---|---|
| LN611 | 0.157 | 0.178 | 2.6 | 35 | 22 | 19 | 8.4 |
| LN629 | 0.483 | 0.381 | 2.8 | 23 | 15 | 12 | 5.7 |
| LN692 | 0.762 | 0.162 | 3 | 6 | 4 | 3 | 1.5 |

FIG. 5 is a diagrammatic view of the diffuser 8 and support 10 in partial perspective, showing the radiation diagram of the diffuser for a ray 38 having normal incidence on the diffuser. FIG. 5 shows various rays, more precisely the extreme rays 40 and 42, 44 and 46 in the horizontal and vertical directions. It also shows the projection 50 of the radiation diagram in the plane of the opaque layer. The radiation diagram is elongated so that all of the scattered rays originating from ray 38 pass through the opaque layer.

FIG. 6 shows the effect of an error in alignment of the diffuser and focusing element support. In the plane of opaque layer 20, there are shown the openings or apertures 22 and the trace of the radiation diagram for exact alignment at 52 and an error in alignment at 54. The angle between the direction of the lenticular elements and the direction of the major axis of the diffuser radiation diagram is marked 6; in the case of reference numeral 52, this angle 6 has zero value; it has a non zero value in the case shown at 54. On a 800×600 mm screen, a 2 mm positioning tolerance at the side of the screen leads to an angle δ of the order of 0.3 degrees. A 1 mm tolerance—achievable in practice without particular difficulties under industrial conditions—leads to an angle δ of 0.15°.

One can use this value of angle δ as an upper limit on variations introduced in luminous ray angles as a result of an alignment error of diffuser and support. One can then diminish, by this value of δ, the vertical angle of the diffuser's radiation diagram so as to ensure transmission of all the light. The angle of the diffuser is then chosen to be equal to α-δ, to ensure all the light emitted by the diffuser passes through the apertures in the opaque layer and reaches the user.

We shall further consider the example of a 70 inch diagonal screen i.e. with picture dimensions of 1550 mm by 872 mm in a 16/9 format. The support 10 has 250 lenticular elements per inch. The black matrix has an aperture ratio of 20% equivalent to an aperture size of 20 μm. Horizontal resolution is 1500 pixels per line corresponding to a 1 mm pixel. If we consider an alignment tolerance of ±1 μm at the edges of an individual pixel, an angle δ of 1/00 radians is obtained. Alignment tolerance at the edges of a 1500 mm long screen is ±750/500 equivalent to ±1.5 mm. If an alignment tolerance of 0.75 mm is imposed at the screen edge—which is perfectly feasible industrially—an alignment tolerance less than 0.5 μm at an individual pixel is obtained. This ensures excellent optical transmission and the possibility of still further improving contrast, for example by decreasing the aperture ratio to 10% for the black matrix.

The tables below give examples of angles α and β for various aperture angles X% in the opaque layer. We have considered examples of refractive index n of 1.5. The calculations were done using the formulae given above with reference to FIGS. 2 and 3.

A is chosen to be compatible with the required resolution; for the vertical, a pair of lines—a black line and a white line—can be projected over a distance 2·A; a value of A of 150 μm is taken by way of example. The emission angle for a surface diffuser at half-luminance is approximately equal to two-thirds of the angle at extinction.

Application to Television

In the horizontal direction, a diffuser and consequently the screen emit at a half-luminance at ±40°; a value of ±48° is possible. The table gives angles in degrees, for the vertical, with
the angle α (L/2) at half-luminance for the diffuser:
the angle β (L/2) at half-luminance and β at extinction for the screen.

X% is the aperture ratio of the opaque layer, as explained above.

| | X % | 30 | | 30 | 20 | | 20 | 10 | | 10 | | 0 |
|---|---|---|---|---|---|---|---|---|---|---|---|---|
| A | r | α | 30 | β | α | 20 | β | α | 10 | β | 0 | β₀ |
| (mm) | (mm) | (L/2) | β | (L/2) | (L/2) | β | (L/2) | (L/2) | β | (L/2) | βₒ | (L/2) |
| 0.150 | 0.150 | 3.2 | 21 | 13 | 2.1 | 19.5 | 11.5 | 1.1 | 18 | 10 | 16 | 7.3 |
| 0.150 | 0.200 | 2.4 | 15.5 | 10 | 1.6 | 14 | 8.5 | 0.8 | 13 | 7 | 11.5 | 5.4 |

In the vertical direction, the habitual television specification requires a half luminance angle P(L/2) at the screen output better than ±10°. r=0.150 mm is suitable with a lenticular elements thickness e=0.420 mm. Diffusers with a half-luminance emissivity of ±0.5° at ±3° for the vertical are suitable.

Holographic surface diffusers from the POC company can be used. These diffusers have half-luminance angles in the following ranges:
minor axis: ±0.1° at ±18°;
major access: ±5° at ±48°.
   Similarly, Wavefront Technologies Inc., Paramount, Calif., has elliptical surface diffusers which are suitable.

Application to a graphics monitor and elements of a large dimension video wall In a horizontal direction, the usual specification requires a half-luminance angle P(L/2) at the output from the screen greater than ±40°; a value of ±48° is possible. In the vertical direction, the usual specification requires a half-luminance angle P(L/2) at the output from the screen greater than ±30°.

An example, illustrated in FIG. 8, is explained below.

We mentioned above the example of a surface holographic diffuser. We note the very small backscattering from a holographic diffuser. This diffuser has the advantage of having a readily adaptable scattering diagram; one could even provide for several lobes in the same horizontal direction. This diffuser also has the advantage discussed in FIG. 1 of the article of J. M. Tedesco cited above of re-directing light incident in this cone, even light not having normal incidence, into the scattering cone. This allows the addition of a further diffuser in the assembly, with a small scattering angle. One could also use, at the entry to the Fresnel lens, a vertical lenticular element; some spreading of rays in the horizontal plane has no effect on the radiation diagram of the holographic diffuser. One can also use a diffuser with a conical scattering diagram with an angle less than the vertical angle of the holographic diffuser; such a diffuser could for example be provided on the entry surface 12 of diffuser 8. In both cases, the presence of such a diffuser contributes to limiting speckle effects.

In the case of a conical diffuser of angle 2° (half angle at half luminance, equivalent to ±3.5° at extinction) on surface 12, resolution is slightly deteriorated since the incident beam size increases through diffuser 8; at the entry to diffuser surface 14 a dot size of 2×2 mm×tan(3.5°), equivalent to 250 microns for a 2 mm thick diffuser is obtained. This degradation is acceptable.

Like in the previous case, a further symmetrical diffuser can also be provided at the entry to the Fresnel lens. In every case, it is advantageous for this supplementary diffuser to have a half-luminance diffusion angle of ±2.5°. Such a diffuser is available from Reflexite Display Optics under reference BP311 or from POC under reference 5° LSD.

One could further arrange such a diffuser at the surface of substrate 24 bonded to the opaque layer, and/or yet again arrange this diffuser on the surface of the lenticular element support before depositing the opaque layer. The solutions may require the use of an adhesive of a different refractive index so as to preserve a complex surface separating two media of differing refractive indices. The solutions make it possible to preserve a smooth surface on the outside of the screen, facing the user, so as to prevent any soiling and increase robustness of the screen.

Thus, it is possible to add to the diffuser having an elongated radiation diagram, one or several supplementary diffusers with, preferably, a low diffusion angle—smaller than the vertical angle of the diffuser with an elongated radiation diagram. This or these supplementary diffuser(s) fulfil one or several of the following functions:
limiting speckle;
limiting moire effects;
further increasing scattering angle for transmitted light.

This or these supplementary diffuser(s) can be surface diffuses and be arranged:
on the surface of substrate 24 against the opaque layer;
underneath the opaque layer;
on the entry surface 12 to diffuser 8;
on the entry surface 4 to Fresnel lens 6.

One could also use, by way of a supplementary diffuser, a three-dimensional diffuser in the Fresnel lens, in the diffuser, in the lenticular elements or in the substrate.

Even with such diffusers, one obtains a screen having, in combination with the Fresnel lens, transmission better than 0.60 or even 0.70 or more.

The speckle phenomenon can appear when a scattering surface struck by a narrow beam reacts like a multitude of small independent sources the emissions of which interfere to create a picture with fine and highly luminous white, and blacks—whence the impression of speckle. Speckle is not a particular problem at large distances like in television and video image wall applications. For a short distance monitor applications, the observer may find this bothersome. In the case of DMD projectors, the micromirror pixel reflects a very thin luminous beam towards the optical system which, although widened by the optical system, reaches the screen pixel at an angle well below 1°; the dot from scattering in the optical system is around 100 microns on the screen and can exhibit speckle as a result of a periodicity of the scattering surface well below 100 microns (see Proceedings of the SPIE, February 1997); this holds also for the surface of a 800 μm×600 μm pixel for a 800 mm×600 mm screen illuminated by a DMD micromirror.

In the vertical direction, there is an integration effect of the phenomenon since a 600 μm height pixel sees as it were its information compressed and then redistributed by 4 horizontal lenticular elements of period A=150 μm.

As explained above, it is possible to minimize this phenomenon by providing one or several conical diffusers, periodic or otherwise, in the screen: the aim here is to widen out the angle the light beam strikes diffuser 8 at by placing a second diffuser in front of it to avoid speckle from the diffuser 8; or minimize speckle by means of a second diffuser after diffuser 8.

We shall now give examples for calculating contrast. As known per se, contrast is representative on the ratio L₀/lₙ between luminance L₀ of the screen in those regions where light is transmitted (ON regions) and the luminance lₙ in those regions where light is not transmitted (OFF regions). Using the following notation:
F, luminous flux in useful lumens incident on the projection screen;
T optical transmission of the screen in %;
G screen gain compared to a Lambert diffuser;
R diffuse reflection coefficient of the screen, in %;
S screen surface area;
E ambient light levels in lux.

Using these notations, contrast C is given by:
C=L₀/lₙ
with L₀=(F·T/n·S)·G
and lₙ=E/πR
   which finally gives
C=(F/E)·(T/R)·(G/S)

For measuring R, the projector is switched off; under ambient lighting, the luminance lₙ₀ of a reflective Lambert diffuser (for example of MgO) placed against the screen surface is measured. Next, screen luminance lₙ is measured. Coefficient R is now lₙ/lₙ₀.

For measuring contrast of a projector, the ANSI standard proposes dividing screen surface into 9 equal parts 5 of which are ON and 4 of which are OFF with the ON zones at the four comers and the center; the luminance mean L₀ is measured with a photometer on the 5 ON zones, the mean lₙ being the means of luminances measured on the 4 OFF zones, the screen being under ambient lighting with the projector switched off, ambient lighting being a mean for measurements made with a luxmeter on the different zones of the screen.

Under these conditions, for the screen of FIG. 1, contrast can be calculated as follows. The diffuse reflection R can reach 1.5% for an aperture value X% of 20%, giving R=2% for an aperture value of 30%.

Diffuse reflection R of the screen is limited in view of the rear position of diffuser 8 with respect to support 10, which constitutes the originality of the invention with respect to the state of-the-art.

For television applications, luminous flux is low to limit power consumption; typically, we have a power F less than 500 lumens. A transmission of 60%, an illumination value of 100 lux and a 1 square metre surface area give, for an aperture X% of 20°, a contrast of:
C=(500/100)·(60/1.5)·G=200·G

In a television application, flat emission is looked for, and the gain is typically greater than 2.5 compared to a Lambert profile. Contrast is better than 500.

In a monitor application, luminous flux of the monitor can reach 1000 lumens. Emission is more homogeneous, leading to a gain better than 1.5. Contrast is:
C=400·G

and is consequently typically better than 600. Screen contrast is consequently better than 500. This is a reasonable calculation taking account of the low gain of 2.5 proposed and the transmission T which can be greater than 0.70; in practice, screen gain is higher, which would further increase contrast.

The diffuse reflection coefficient of the screen, R, is given as follows:
R=R₁+R₂
R₁=diffuse reflection coefficient of the anti-glare layer
R₂=diffuse reflection coefficient of the screen without anti-glare layer
R₁=1% for a moth-eye type plastic anti-glare layer
R₂=R₀X%²

This value for diffuse reflection R₂ is explained as follows; the lenticular element with an etched opaque layer plays the role of a neutral filter for ambient light passing through it; this light is subject to back-scattering by the internal diffuser or by the holographic diffuser, and passes again through the filter formed from the opaque layer to go towards the observer. With a surface area of the black matrix apertures of X%, ambient light is degraded to a minimum by a coefficient of X%². If the surface diffuser 14 back-scatters R0% of stray light, and then the diffuse reflection coefficient of the screen, in the absence of the anti-glare layer, is R₂=R₀ X%².

For a surface diffuser, R₀ is less than 10% (see Tedesco article above).

For X%=20%, we have R₂=0.4% and R=1.4%

For X%=30%, we have R₂=0.9% and R=1.9%

which is consistent with the values for R given above for screen contrast evaluation.

The screen provides better resolution than that of the state-of-the-art. Toppan (Japan) has announced vertical lenticular elements 0.150 mm wide and 0.098 mm wide for the future; the corresponding resolution in pl/mm, for a period of two lenticular elements being 3.3 pl/mm to 5 pl/mm in the future. The screen discussed in the examples has, in the horizontal direction, a resolution which is that of diffuser 8 employed, and which is better than 10 pl/mm. In the vertical direction, resolution is less important for television applications; resolution is given by the number of line pairs visible per mm of screen. It depends, in the examples discussed, on the size of the lenticular elements, one pair of lines corresponding to two lenticular elements.

The screens discussed in the examples can typically allow one or several of the following characteristics to be achieved:
a contrast better than 500 with a flux of 500 lumens for 100 lux ambient;
a vertical angle of view at extinction better than or equal to ±60% (±30% at half luminance);
a horizontal angle of view at extinction better than or equal to ±72° (±48° at L/2);
a resolution in the horizontal direction better than 10 pl/mm
a resolution in the vertical direction better than 3 pl/mm
and a transmission T greater than or equal to 0.70, with the Fresnel lens.

Numerous patents describe how to make non-spherical lenticular elements for correcting astigmatism and focusing and spreading light emitted perpendicular to the lenticular element axis: U.S. Pat. Nos. 4,387,959, 4,490,010, 4,432,010, 6,256,145—the latter two envisage ellipsoid lenticular elements with ellipse eccentricity ε equal to the inverse of refractive index n for minimizing focusing aberrations. The teachings of these various documents can be used and applied to the focusing elements of the support.

FIG. 7 is an example of a screen with non-spherical lenticular elements; the Fresnel lens is also shown. The same notations are used as in FIGS. 2 and 3, except where indicated below. The lenticular elements are cylindrical and rest on arcs of ellipse, of eccentricity ε equal to the inverse of refractive index n1 of the material used for correcting focusing aberrations and limiting the size of the apertures in the opaque layer. The semi-major axis of the ellipse, i.e. the radius of the imaginary external circle in which the ellipse is inscribed is denoted by a. Half the minor axis, i.e. the radius of the imaginary Inner circle inscribed in the ellipse is denoted by b. O is the center of ellipse, F1, F2 are its two foci and c is a distance OF1 or OF2 between the center and one focus. The plane surface of support 10 is practically the focal plane of lenticular elements 18, containing the foci F2. Eccentricity ε is c/a and 1/N1. The ellipse is the set of points M obeying:
F1M+F2M=2a,
and consequently
b²+c²=a² which leads to a=b·n1/4(n₁²−1)

FIG. 7 is an example of lenticular elements with the following values:
b=0.100 mm
n1=1.5
a=0.134 mm
c=0.090 mm
e=a+c=0.224 mm
A=150 μm
X%=20%.

The axis XX′ is used to construct the limiting ray 32 delivered by diffuser 8. This ray passes at the edge of aperture 22 in opaque layer 20 and practically through the center O, in view of the small value of the angle α between ray XX′ and the axis F1F2 of the two foci (or the normal to the screen). We have
tan α=A/2·X%/c [symbol] α=9.5°
which in the example considered, gives a half-luminance emission for the diffuser of 9.5°×⅔, equal to 6.4°. We also have
tan γ=A/2·(1+X%)/D
with D close to F1F2=2c in view of the choice of A
sin β=n1·sin γ
giving
γ=27°
β=43° at extinction and β(L/2)=20° at half luminance, which is too high for television applications and too low for graphics monitor applications.

Increasing the value of β(L/2) up to ±30° or more is possible by applying a second surface diffuser in the apertures of the opaque layer; this contributes to minimizing speckle if appropriate.

Clearly, the invention is not limited to the embodiments described. Regarding manufacture, FIG. 2 shows the lenticular elements obtained by molding, extrusion or, for a fine structure with the value of A<0.200 mm, by cross linking a photopolymer resin with a appropriate radiation (UV, . . . ) on a thin support as suggested in a JP-A-3-12704, U.S. Pat. No. 4,083,626 and elsewhere. Tedesco cited above envisaged this photopolymer method for replicating a diffusing surface on a thin or rigid support; this can be used for providing the main diffuser 8 of the invention and the other diffuser or diffusers for minimizing screen speckle.

In the examples of the figures, the screen is used in a rear projection application, with a Fresnel lens. In the examples proposed, we have considered a distance A of 150 microns between lenticular elements. One could also choose a greater distance, for example 500 microns at the most; a value of 250 microns at the most nevertheless improves resolution.

To conclude, in the various examples discussed above:
screen resolution in the horizontal direction is given by the main diffuser 8;
screen emission in the vertical direction is provided principally by the lenticular element support; for the television application, correcting astigmatism by sphericity is not necessarily useful and the lenticular elements can be quasi-cylindrical with circular section, which has the advantage of ease of manufacture; this differs fundamentally from the state of-the-art which employs vertical non-spherical lenticular elements for horizontal screen emission.

In the case of the graphics monitor and video image wall application in the examples of the invention, the vertical emission angle is provided by the non-spherical horizontal lenticular elements.

FIG. 8 shows a lenticular element support 10 adapted to the graphics monitor and video wall applications. There are shown the opaque layer provided with apertures with X%=20%. The Fresnel lens 6, diffuser 8, substrate 24 are not shown.

The characteristics of FIG. 8 are as follows:
a=0.115 mm
b=0.085 mm
c=0.075 mm
e=0.190 mm
A=0.150 mm
X%=20%
n=1.5
which gives: extinction angle β=±60°
and half-luminance angle β (L/2)>±30°

The associated diffuser 8 has the following characteristic angles:

| | | |
|---|---|---|
| X % = 20% | α = 11.5° | α(L/2) = 7.6° |
| X % = 10% | α = 5.7° | α(L/2) = 3.8° |
| X % = 5% | α = 2.8° | α(L/2) = 1.9° |

on the minor axis, which is in the field of the achievable. On the major axis, the half-luminance angle is ±40° or even ±48° (see holographic diffuser from POC). The asymmetric surface diffuser from Reflexite Display Optics sold under reference SN 1375 with a half-luminance angle α of ±7% on the minor axis for an aperture value X%t=20% can also be used. The angle of scatter on the major axis of this diffuser is ±33° at half luminance; this value is low but can be improved.

Producing support 10 involves the photopolymer method (see above) for forming the lenticular elements 18 on a support base film around 0.075 mm thick.

FIG. 9 shows a support 10 adapted to the television application. The characteristics of FIG. 9 are:
a=0.200 mm
b=0.150 mm
c=0.135 mm
e=0.335 mm
A=0.150 mm
X%=20%
n=1.5
   giving an extinction angle of β=±26° and half-luminance angle of (L/2)=13.5°.

The associated diffuser 8 has the following characteristic angles

| | | |
|---|---|---|
| On the minor axis: | α = ±6.4° | α(L/2) = ±4.2° for X % = 20% |
| | α = ±3.2° | α(L/2) = ±2.1° for X % = 10% |
| | α = ±1.6° | α(L/2) = ±1° for X % = 5% |

on the major axis: α_{H}=±72° α_{H}(L2)=±48° in the case of the holographic diffuser from POC.

A support 10 thicker than that for FIG. 8 can be provided using the known techniques in the art.

The examples illustrated by FIGS. 8, 9 or 3 illustrate well the spirit of the invention: i.e. a surface diffuser emitting on the major axis with a half-luminance angle of ±40°, or even ±48° and on the minor axis with a half-luminance angle of ±1° to ±4°; the association with this diffuser of support 10 with A=0.150 mm further having either the characteristics of FIG. 8, or those of FIGS. 9 and 3 leading to a screen respectively customized for a graphics monitor application or TV application.

In both cases, a diffuser having the smallest possible angle on the minor axis is applied to constitute apertures in the opaque layer with the X% value minimized; with the stated aim of increasing screen contrast.

FIGS. 10a-10d show constructional details of a screen, and FIG. 11 shows a cross section through a screen on an enlarged scale. FIG. 10a shows the substrate 24 on which support 10 with its lenticular elements is laminated onto the opaque layer side thereof. After this operation, the basics surface identified by reference numeral S1 in the diagram, can be cut out accurately, in correspondence with the axis of the lenticular elements.

FIG. 10b shows a frame 72 on which there is laminated diffuser 8, with active surface 14. The basic surface of frame 72, identified by reference numeral S2, can be accurately cut-out or machined after lamination of diffuser 8, in correspondence with the major axis of elliptical emission of diffuser 8. This diagram also shows the position of the Fresnel lens. The latter is mounted onto frame 78 or laminated thereon (shown in FIG. 10c); the basic surface of frame 78 can be, like that of frame 72, cut-out or machined actually as a function of the position of the Fresnel lens in the frame.

FIG. 10c is a sectional view of the assembled screen. An outer frame 82 shown in detail in FIG. 10d, is employed. FIG. 10d shows a perspective view of frame 82, with the securing apertures on the projector chassis. For a 70 inch projected 16/9 format image, i.e. 1550×872 mm, frame 82 would have dimensions of around 1700×1000 mm. with a thickness of around 50 mm.

To obtain the assembled screen of FIG. 10c, the procedure is as follows. Firstly, substrate 24 is assembled into outer frame 82. The latter has a reference plane 70 which is accurately machined and which receives surface S1 of the substrate. Following this, frame 72 is assembled into outer frame 82 with provision of a spacer 72 between frame 72 and substrate 24. Surface S2 comes into contact with reference plane 70, which ensures good horizontal alignment of the diffuser and lenticular elements. The distance between the diffuser and the lenticular elements is adjusted to the desired dimension by means of the spacer 72. Next, frame 78 is mounted into outer frame 82. Surface S3 comes into contact with reference plane 70, which ensures good horizontal alignment of the Fresnel lens and diffuser; precision over surface S3 is not an essential feature considering the Fresnel lens has symmetry of revolution. One could also provide for the second frame not to bear against the reference surface. The distance between Fresnel lens 6 and the input surface of diffuser 8 is adjusted thanks to the shaping of frames 72 and 78; the use of a spacer would also be possible. Finally, hard foam material 76 and a cover 80 are mounted to support the screen element assembly.

The assembly of FIGS. 10a-10d is given by way of example; it could apply to any other type of screen having three elements. It ensures temperature- and relative humidity insensitive positioning of the respective horizontal axes of diffuser 8 and diffuser 10. It also ensures excellent positioning of the various screen parts, using simple components and a process readily implemented industrially.

FIG. 11 shows a view on a larger scale of elements of FIG. 10c.

The examples above show the use of a structure composed of three separate elements, allowing firstly all screen characteristics to be optimized and secondly, adaptation to all applications (notably television and graphics monitors). The three elements are successively:
the Fresnel lens with its active surface directed towards the viewer; the role of the lens being to collimate into a cylindrical beam, the conical light beam emitted by the projector;
a diffuser, preferably a surface diffuser, having a radiation diagram that is elongated with a horizontal major axis; the role of the diffuser being to transform, without significant deterioration of resolution, the incident light data cylindrical beam into an elliptical been having a horizontal major axis; diffuser emissivity in the vertical axis is limited to the strict minimum compatible with mass production of the diffuser;
a lenticular support having a black matrix on the surface thereof constituting the output, centered on the horizontal lenticular array of the input surface; this support is bonded, black matrix side, onto a generally transparent substrate of the screen.

The function of the support is that of:
transforming the horizontal lobe emission, and vertically as thin as possible of the diffuser, into the definitive emission of the screen: the horizontal emissivity angle is then that of the diffuser, the vertical emissivity angle being defined by the geometry of the lenticular elements of the support;
thanks to the non-spherical structure of the lenticular elements, that of minimizing focusing aberrations at the apertures in the black matrix; this allows the dimensions of said apertures to be limited, consequently truly optimizing contrast;
transferring, with maximum optical yield close to 90%, the luminous flux emitted by the diffuser through the black matrix thanks to the absence of diffusing elements in the bulk of the support;
ensuring mechanical strength for the assembly, the support being bonded at the black matrix side onto a substrate on the viewing side.

1-26. (canceled)

27. A display screen comprising, along the direction of propagation of projected light:
a diffuser (8) having an elongated radiation diagram with a horizontal major axis;
a support (10) with a light entry surface (16) having cylindrical focusing elements (18) substantially parallel to the major axis of the radiation diagram of the diffuser, the support further having an opaque layer (20) with apertures (22) adapted to allow the light focused by said focusing elements to pass.

28. The display screen of claim 27, wherein the diffuser has a radiation diagram with a half-luminance angle less than ±10%, in the vertical direction.

29. The display screen of claim 27, wherein the diffuser has a radiation diagram the elongation of which is greater than 6.

30. The display screen of claim 27, wherein the apertures in the opaque layer make up at the most 30% of the total surface.

31. The display screen of claim 27, wherein the diffuser is a surface diffuser having an active surface (14).

32. The display screen of claim 31, wherein the active surface (14) of the diffuser (8) is directed towards said support.

33. The display screen of claim 31, wherein the diffuser is a holographic diffuser with an active surface opposite the support.

34. The display screen of claim 27, further comprising a supplementary diffuser.

35. The display screen of claim 34, wherein the supplementary diffuser is conical.

36. The display screen of claim 34, wherein the supplementary diffuser has a maximum scattering angle less than the vertical scattering angle of said elongated radiation diagram diffuser.

37. The display screen of claim 34, wherein the supplementary diffuser is a surface diffuser formed on a surface of said elongated radiation diagram diffuser (8).

38. The display screen of claim 34, wherein the supplementary diffuser is a surface diffuser formed adjacent to said opaque layer (20).

39. The display screen of claim 27, further comprising a substrate (24) disposed above said opaque layer (20).

40. The display screen of claim 27, further comprising a Fresnel lens with its active surface directed towards said elongated radiation diagram diffuser (8).

41. The display screen of claim 40, further comprising a vertical lenticular element at the entry to said Fresnel lens (6).

42. The display screen of claim 41, wherein the supplementary diffuser is a surface diffuser formed on the entry surface (4) of said Fresnel lens (6).

43. The screen of claim 40, wherein an optical transmission is greater than or equal to 0.70.

44. The screen of claim 40, wherein a half-luminance emission angle in a horizontal plane is greater than ±48° and wherein an extinction angle in the horizontal plane is greater than ±72 degrees.

45. The display screen of claim 40, wherein a resolution on a horizontal axis is greater than 10 line pairs per mm.

46. The display screen of claim 39, further comprising a Fresnel lens with its active surface directed towards said elongated radiation diagram diffuser (8) and wherein the Fresnel lens, the diffuser, the support and the substrate are assembled by peripheral bonding.

47. The display screen of claim 46, further comprising
a first frame (72) supporting the diffuser (8);
a second frame (78) supporting the Fresnel lens;
an outer frame (82), in which the substrate (24), the first frame (72) and the second frame (78) are mounted.

48. The display screen of claim 47, wherein the outer frame (82) has a reference plane (70) and wherein a base surface (S1) of the substrate (24) and a base surface (S2) of the first frame abut against said reference plane.

49. The display screen of claim 39, further comprising on at least one non-scattering surface, an anti-glare layer, such as a moth-eye type anti-glare layer.

50. The display screen of claim 39, wherein the support, at the side of the opaque layer, is bonded onto the substrate.

51. A rear projector unit comprising
a projector (2) and
a display screen comprising, along the direction of propagation of projected light:
a diffuser (8) having an elongated radiation diagram with a horizontal major axis;
a support (10) with a light entry surface (16) having cylindrical focusing elements (18) substantially parallel to the major axis of the radiation diagram of the diffuser, the support further having an opaque layer (20) with apertures (22) adapted to allow the light focused by said focusing elements to pass; and
a Fresnel lens with its active surface directed towards said elongated radiation diagram diffuser (8);
wherein the Fresnel lens is adapted to collimate the light projected by the projector (2) onto the display screen.

52. The rear projector unit of claim 51, wherein the unit has a contrast higher than 500 under ambient illumination of 100 lux, for a luminous flux from said projector of 500 lumens.
